(19) United States
(12) Patent Application Publication
(10) Pub. No.: US 2012/0268225 A1
(43) Pub. Date: Oct. 25, 2012

(54) SOLENOID ACTUATOR WITH SURFACE FEATURES ON THE POLES

(75) Inventors: Deepak Pitambar Mahajan, Bangalore (IN); Renukaprasad Narayanswamy, Bangalore (IN)

(73) Assignee: HONEYWELL INTERNATIONAL INC., Morristown, NJ (US)

(21) Appl. No.: 13/090,050

(22) Filed: Apr. 19, 2011

(51) Int. Cl. H01F 7/08

(52) U.S. Cl. 335/261

(57) ABSTRACT

A solenoid actuator is provided that includes a coil, a return pole, and an armature, all at least partially disposed within a housing. The return pole defines an armature seating surface that has a plurality of first surface features formed therein. The armature is axially movable in the housing between a first position and a second position. The armature defines a return pole engagement surface that has a plurality of second surface features formed therein. When the armature is in the first position, the return pole engagement surface is spaced apart from the armature seating surface. When the armature is in the second position, the return pole engagement surface engages the armature seating surface and the first and second surface features interlock.

### TECHNICAL FIELD

The present invention generally relates to solenoids, and more particularly relates to a solenoid actuator with surface features formed on the poles.

### BACKGROUND

A solenoid is an electromechanical device that converts electrical energy into mechanical work, and can be a push-type or pull-type solenoid, depending upon the application. The basic components of a solenoid include a coil, a magnetically permeable shell or case, a return pole or fixed pole, and a movable plunger or armature. The coil is configured, upon being electrically energized, to generate a magneto-motive force. The magnetically permeable shell or case implements a magnetic circuit, and directs the magneto-motive force into the movable armature and a return pole or fixed pole. As a result, the movable armature and return pole or fixed pole are magnetized with opposite polarities. The opposing magnetic polarities cause the armature to move toward and engage the return pole or fixed pole.

The portions of the armature and return pole or fixed pole that engage each other when the coil is energized have complementary cross sectional shapes. These cross sectional shapes may be determined based, at least in part, on the force and the stroke requirements of the solenoid. In many instances, the cross sectional shapes and associated force and stroke requirements may provide less than optimum weight, size, and force-stroke characteristics.

Accordingly, it is desirable to provide a solenoid that, for armatures and return poles or fixed poles of various cross sectional shapes, exhibits improved weight, size, and force-stroke characteristics as compared to known solenoids. The present invention addresses at least this need.

### BRIEF SUMMARY

In one embodiment, a solenoid actuator includes a housing, a coil, a return pole, and an armature. The coil is disposed within the housing. The return pole is fixedly coupled to, and is at least partially disposed within, the housing, and includes a return pole first end and a return pole second end. The return pole first end is at least partially surrounded by the coil and defines an armature seating surface. The armature seating surface has a plurality of first surface features formed therein. The armature is disposed at least partially within the housing and is axially movable therein between a first position and a second position. The armature includes an armature first end and an armature second end. The armature first end is at least partially surrounded by the coil and defines a return pole engagement surface. The return pole engagement surface has a plurality of second surface features formed therein. When the armature is in the first position, the return pole engagement surface is spaced apart from the armature seating surface. When the armature is in the second position, the return pole engagement surface engages the armature seating surface and the first and second surface features interlock.

In another embodiment, a solenoid actuator includes a housing, a coil, a return pole, and an armature. The coil is disposed within the housing. The return pole is fixedly coupled to, and is at least partially disposed within, the housing, and includes a return pole first end and a return pole second end. The return pole first end is at least partially surrounded by the coil and defines an armature seating surface. The armature seating surface has a plurality of protrusions formed thereon and extending therefrom. The armature is disposed at least partially within the housing and is axially movable therein between a first position and a second position. The armature includes an armature first end and an armature second end. The armature first end is at least partially surrounded by the coil and defines a return pole engagement surface. The return pole engagement surface has a plurality of grooves formed therein. When the armature is in the first position, the return pole engagement surface is spaced apart from the armature seating surface. When the armature is in the second position, the return pole engagement surface engages the armature seating surface and each protrusion is at least partially disposed within a different one of the grooves.

In still another embodiment, a solenoid actuator includes a housing, a coil, a return pole, and an armature. The coil disposed within the housing. The return pole is fixedly coupled to, and is at least partially disposed within, the housing, and includes a return pole first end and a return pole second end. The return pole first end is at least partially surrounded by the coil and defines an armature seating surface having a first cross sectional shape. The armature seating surface further has a plurality of grooves formed therein, and each groove has a saw tooth cross sectional shape. The armature is disposed at least partially within the housing and is axially movable therein between a first position and a second position. The armature includes an armature first end and an armature second end. The armature first end is at least partially surrounded by the coil and defines a return pole engagement surface having a second cross sectional shape that is complementary to the first cross sectional shape. The return pole engagement surface further has a plurality of protrusions formed thereon and extending therefrom. Each protrusion has a saw tooth cross sectional shape. When the armature is in the first position, the return pole engagement surface is spaced apart from the armature seating surface. When the armature is in the second position, the return pole engagement surface engages the armature seating surface and each protrusion is at least partially disposed within a different one of the grooves.

Furthermore, other desirable features and characteristics of the solenoid actuator will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1A and 1B depict a simplified cross section view of one exemplary embodiment of a solenoid actuator in a first position

FIGS. 2A and 2B depict the simplified cross section view of the exemplary solenoid actuator of FIGS. 1A and 1B in a second position;

FIGS. 3 and 4 depict alternative configurations of portions of the solenoid actuator depicted in FIGS. 1A, 1B and 2A, 2B;

FIG. 5 depicts an alternative configuration of an exemplary embodiment a solenoid actuator in a first position;

FIG. 6 depicts magnetic field density line plots for the solenoid actuator depicted in FIG. 1 and for a similarly configured, conventional solenoid actuator;

FIGS. 7 and 8 depict graphs of force versus stroke for the solenoid actuators depicted in FIGS. 1-5 and for a similarly configured, conventional solenoid actuator; and

FIG. 9 depicts another alternative configuration of portions of the solenoid actuator depicted in FIGS. 1A, 1B and 2A, 2B.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

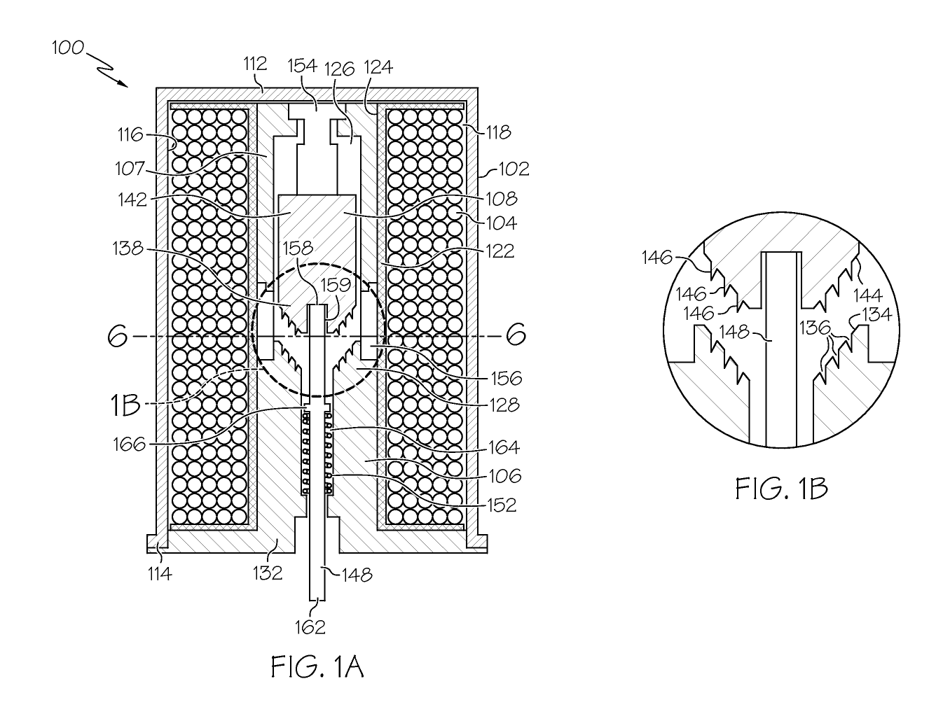

Referring to FIGS. 1A and 1B, a simplified cross section view of one exemplary embodiment of a solenoid actuator 100 is depicted. The solenoid actuator 100 includes at least a housing 102, a coil 104, a return pole 106, a yoke 107 and a movable armature 108. The housing 102 is configured to include a first end 112, a second end 114, and an inner surface 116 that defines a housing cavity 118. The housing 102 may comprise any one of numerous materials having a relatively high magnetic permeability such as, for example, magnetic steel. The housing 102, in addition to having a plurality of components disposed therein, provides a flux path (together with the return pole 106, yoke 107, and movable armature 108) for magnetic flux that the coil 104 generates when it is electrically energized.

The coil 104 is disposed within the housing 102 and is adapted to be electrically energized from a non-illustrated electrical power source. As noted above, when it is energized, the coil 104 generates magnetic flux. In the depicted embodiment, the coil 104 is wound around a bobbin 122. The bobbin 122 preferably comprises a non-magnet material, and includes an inner surface 124 that defines a cavity 126.

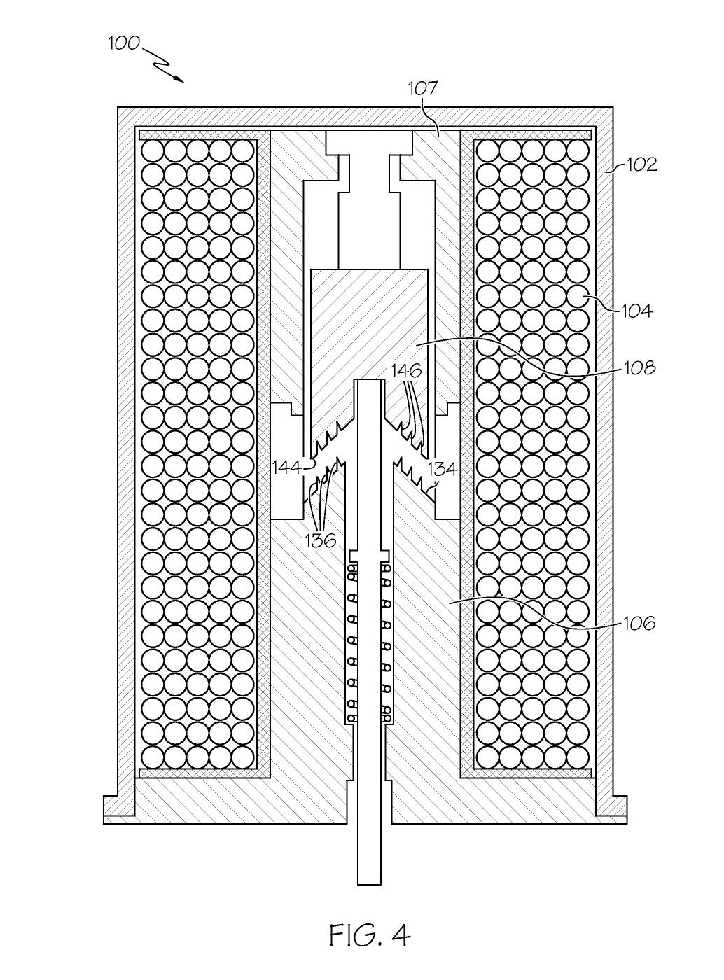

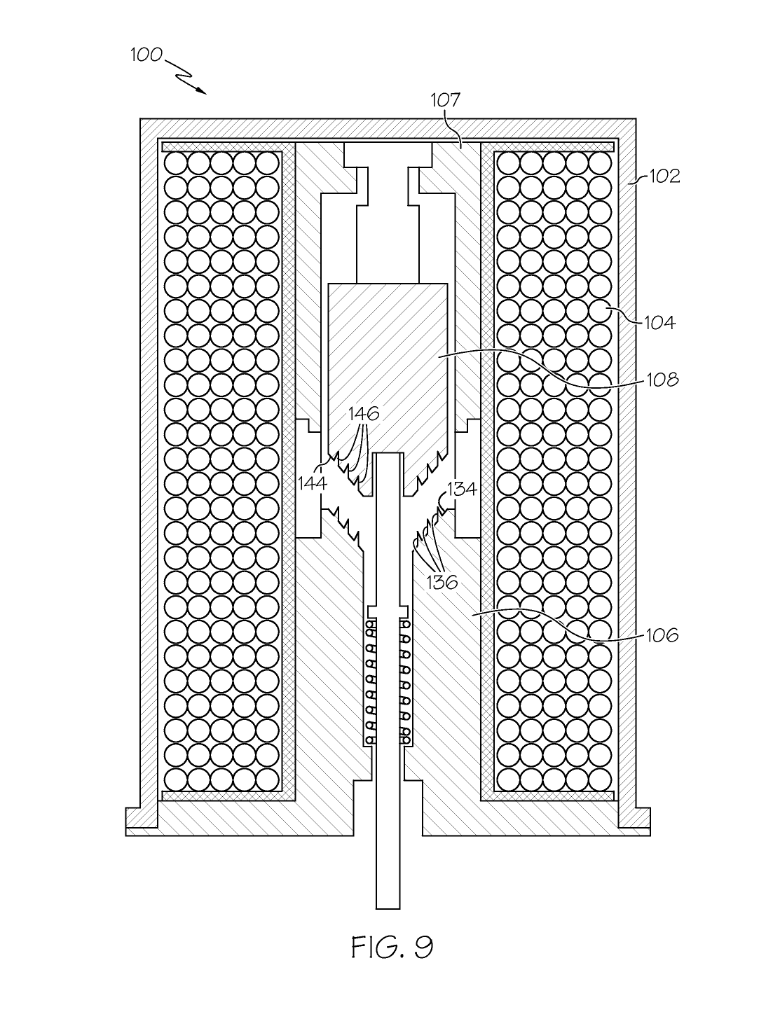

The return pole 106 is fixedly coupled to the housing second end 114 and extends into the cavity 126. The return pole 106 preferably comprises a material having a relatively high magnetic permeability and, together with the housing 102, yoke 107, and armature 108, provides a magnetic flux path for the magnetic flux that is generated by the coil 104 when it is energized. The return pole 106 includes a return pole first end 128 and a return pole second end 132. The return pole first end 128 extends into the housing cavity 118 and the cavity 126. The return pole first end 128 is surrounded by, or at least partially surrounded by, the coil 104, and defines an armature seating surface 134. The armature seating surface 134 has a plurality of first surface features 136 formed therein, the purpose of which is described further below. It will be appreciated that the number and configuration of the first surface features 136 formed in the armature seating surface 134 may vary. In the depicted embodiment, the armature seating surface 134 has three grooves 136 formed therein. However, other embodiments may include more or less than this number of first surface features 136, and the first surface features 136 may be implemented as protrusions (see FIGS. 4 and 9).

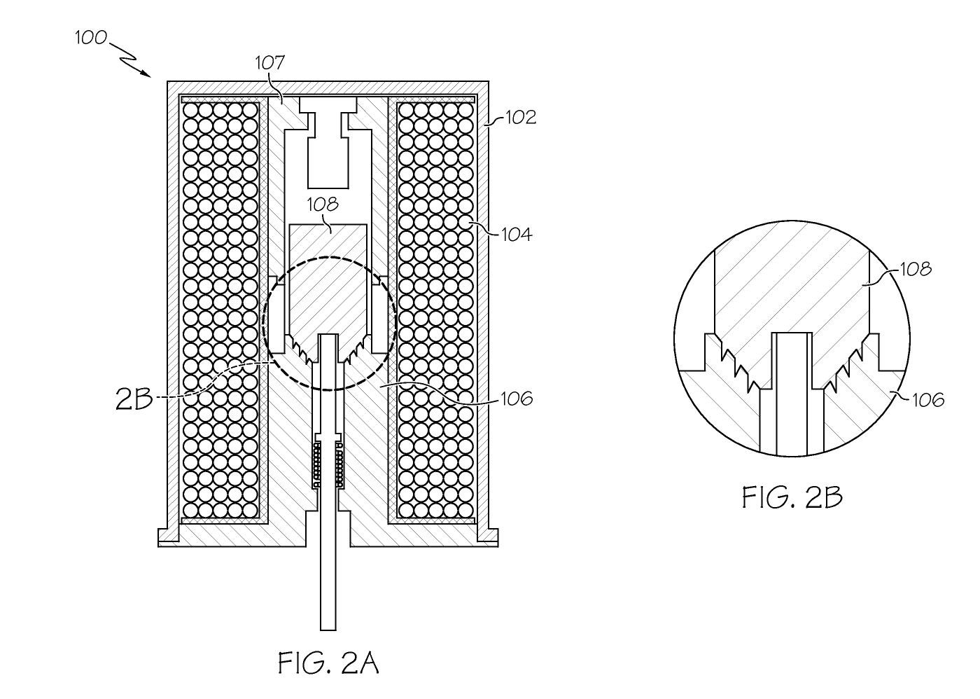

The armature 108 is disposed at least partially within the housing 102 and extends at least partially into the cavity 126. The armature 108 preferably comprises a material having a relatively high magnetic permeability and, as noted previously, together with the housing 102, yoke 107, and return pole 106, provides a magnetic flux path for the magnetic flux that is generated by the coil 104 when it is energized. The armature 108 is axially movable within the cavity 126 between a first position, which is the position depicted in FIGS. 1A AND 1B, and a second position, which is the position depicted in FIGS. 2A AND 2B. Because the armature 108 is movable within the cavity 126, the armature 108 may additionally include, at least in some embodiments, a friction-reducing coating on its outer surface.

The armature 108 additionally includes an armature first end 138 and an armature second end 142. The armature first end 138 is at least partially surrounded by the coil 104, and defines a return pole engagement surface 144. A plurality of second surface features 146 are formed in the return pole engagement surface 144. The purpose of the second surface features 146 will also be described further below. It will be appreciated that the number and type of second surface features 146 formed in the return pole engagement surface 144 may vary. Preferably, however, there are equal numbers of first surface features 136 and second surface features 146. Thus, although the depicted embodiment includes three second surface features 146, other embodiments may include more or less than this number of second surface features 146. Moreover, while the configurations of the first and second surface features 136, 146 may vary, the features are configured to interlock when the armature is in the second position.

The configuration and cross sectional shapes of the first and second surface features 136, 146 may also vary. In the depicted embodiment, the first surface features 136 are each configured as grooves, and the second surface features 146 are each configured as protrusions. In other embodiments, the first surface features 136 may each be configured as protrusions, and the second surface features 146 may each be configured as grooves. Preferably, and as shown most clearly in FIG. 1B, the grooves and the protrusions, whether implemented as the first or second surface features 136, 146, have saw tooth cross sectional shapes. This cross sectional shape, as will be discussed further below, provides a higher magnetic field density in the working air gap and a higher force for a given stroke, as compared to conventional solenoid actuators.

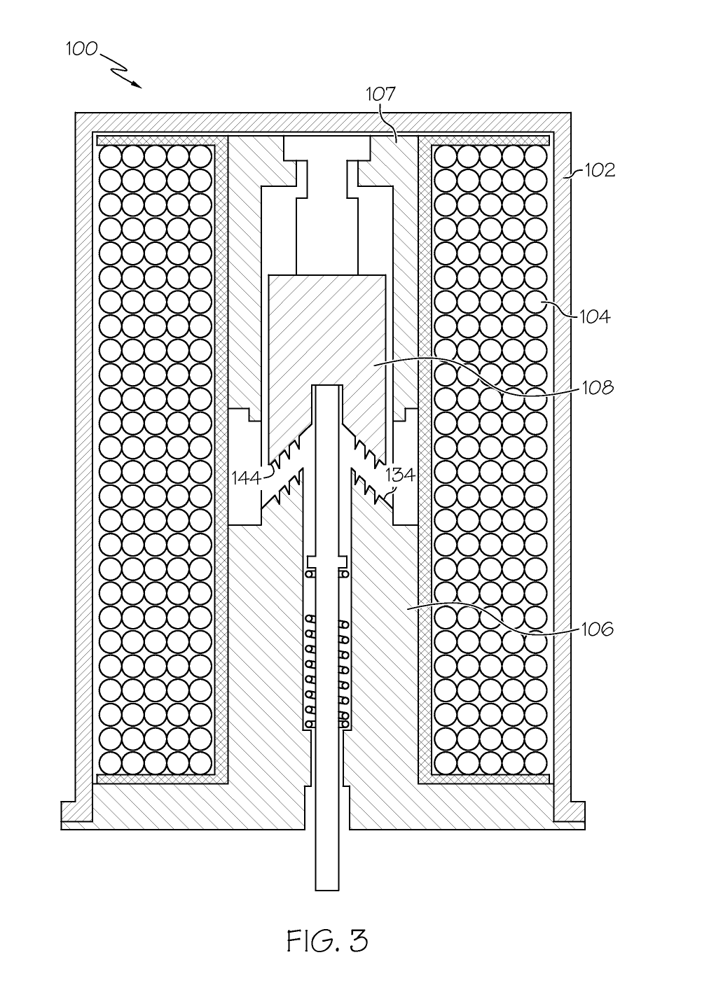

It is additionally noted that the geometry of the armature seating surface 134 is complementary to the geometry of the return pole engagement surface 144. Stated another way, the armature seating surface 134 and the return pole engagement surface 144 have complementary cross sectional shapes. In the embodiment depicted in FIGS. 1A and 2A, the armature seating surface 134 has a concave, substantially conical cross sectional shape, and the return pole engagement surface 144 has a convex, substantially conical cross sectional shape. It will be appreciated that the angle of the conical cross sections may vary. For example, although the angles in the depicted embodiment are about 45-degrees, various other angles may be used. It will additionally be appreciated that the armature seating surface 134 and the return pole engagement surface 144 may have various other complementary geometries, as needed or desired. For example, in some alternative embodiments, which are depicted in FIGS. 3 and 4, the armature seating surface 134 has a convex, substantially conical cross sectional shape, and the return pole engagement surface 144 has a concave, substantially conical cross sectional shape. Examples of other alternative geometries include flat geometries and rounded concave/convex geometries, just to name a few. Moreover, in the embodiment depicted in FIG. 4, the first surface features 136 are implemented as protrusions, and the second surface features 146 are implemented as grooves.

Before proceeding further, it is noted that when the return pole engagement surface 144, and concomitantly the armature seating surface 134, are configured to have substantially conical cross sections, the angle of the conical cross section may be determined, for a given application, based on what is referred to herein as the index number (i), which is defined using the following equation:

$$i = \frac{\sqrt{Force}}{Stroke} ,$$

where Force is the mechanical load requirement, and Stroke is the required stroke length or mechanical displacement of the armature 108. To provide an illustrative, yet non-limiting example, for index numbers between 20 and 50 (e.g., 20<i<50), the angle of the conical cross sections of the armature seating surface 134 and the return pole engagement surface 144 may be about 45-degrees. It will be appreciated, however, that other angles may be used based on the index number to achieve weight economy.

Returning to the description, and with reference once again to FIGS. 1A AND 1B, the depicted solenoid actuator 100 additionally includes an actuation rod 148, a spring 152, a stopper 154, and an interrupter 156. The actuation rod 148 includes a first end 158 and a second end 162. The actuation rod 148 is coupled, via its first end 158, to the armature 108, and extends through a return pole bore 164 that extends between the return pole first end 128 and the return pole second 132. The actuation rod 148 also extends from the housing 102 to its second end 162. The second end 162 is adapted to couple to a non-illustrated component, such as, for example, a valve, that is to be actuated by the solenoid actuator 100. It will be appreciated that the actuation rod 148 may be coupled to the armature 108 using any one of numerous techniques. In the depicted embodiment, however, the actuation rod 148 is coupled to the armature 108 via threads. That is, non-illustrated threads formed on at least a portion of the actuation rod 148 mate with non-illustrated threads in an actuation rod bore 159 that is formed in the armature 108.

The spring 152 is disposed within the housing 102 and is configured to supply a bias force to the armature 108 that urges the armature 108 toward the first position. The spring 152 may be variously disposed to implement this functionality. In the depicted embodiments, the spring 152 disposed within the return pole bore 164 and engages the return pole 106 and lands 166 formed on the actuation rod 148. Thus, the spring 152 supplies the bias force to the armature 108 via the actuation rod 148. In other embodiments, the spring 152 may variously be disposed within the housing 102 to supply the bias force to the armature 108.

The stopper 154 is disposed within the housing cavity 118 between the housing first end 112 and the armature second end 142. The stopper 154 restricts movement of the armature second end 142 once the bias force is applied by the spring 152. The stopper 154 also defines the stroke or mechanical displacement of the armature 108. The stopper may be manufactured from various non-magnetic materials, such as brass or non-magnetic steel (e.g. CRESS 302).

The interrupter 156 is disposed in the cavity 126 between the return pole 106 and the armature 108, and diverts the magnetic flux in the working air gap when the coil 104 is energized. As with the stopper 154, the interrupter may be manufactured from various non-magnetic materials, such as brass or non-magnetic steel (e.g. CRESS 302).

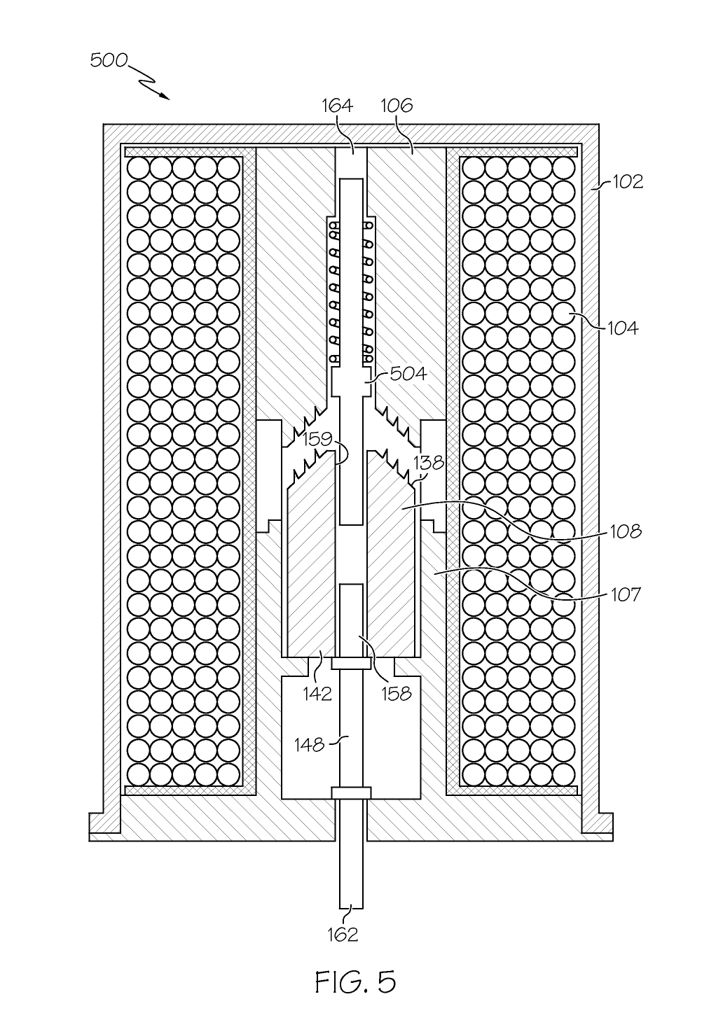

The embodiments depicted in FIGS. 1-4 and described above are configured as what are generally referred to “push-type” solenoid actuators 100. Another typical configuration is generally referred to as a “pull-type” solenoid actuator. One exemplary embodiment of a pull-type actuator 500, which includes a plurality of first and second surface features 136, 146 on the armature seating surface 134 and the return pole engagement surface 144, respectively, is depicted in FIG. 5. The depicted actuator 500 includes many of the same components as the above-described push-type actuators 100. Those components that are the same are referenced using common reference numerals, and detailed descriptions thereof will not be repeated. It is noted, however, that the return pole 106 and armature 108 are disposed differently in the pull-type actuator 500. In particular, the return pole 106 is fixedly disposed adjacent the housing first end 112, and the yoke 107 is coupled to the housing second end 114.

The actuation rod 148 is coupled, via its first end 158, to the armature 108, and extends from the housing 102 to its second end 162. However, rather than extending from the armature first end 138, the actuation rod 148 extends from the armature second end 142. Moreover, the actuation rod 148 does not extend through the return pole 106. The actuation rod 148 may be coupled to the armature 108 via non-illustrated threads that are formed on at least a portion of the actuation rod 148 and non-illustrated mating threads in the actuation rod bore 159 in the armature 108.

The actuator 500 depicted in FIG. 4 also does not include a stopper 154, but does include a stopper rod 504. The stopper rod 504 is disposed within and extends from the return pole bore 164. The stopper rod 504 also extends partially into the actuation rod bore 159, and is coupled, via threads (for example), to the armature 108. The stopper rod 504 defines the stroke or mechanical displacement of the armature 108, and may be manufactured from various non-magnetic materials, such as brass or non-magnetic steel (e.g. CRESS 302).

The armature 108, as noted above, is movable between the first position (FIGS. 1A AND 1B) and the second position (FIG. 2) in response to the coil 104 being selectively energized. More specifically, when the coil 104 is de-energized, the bias force from the spring 152 urges the armature 108 into the first position. In the first position, the return pole engagement surface 144 is spaced apart from the armature seating surface 134. Conversely, when the coil 104 is energized and generating magnetic flux, the magnetic force on the armature 108 overcomes the bias force of the spring 152, and moves the armature 108 into the second position. In the second position, the return pole engagement surface 144 engages the armature seating surface 134, and each of the second surface features 146 is at least partially disposed within a different one of the first surface features 136.

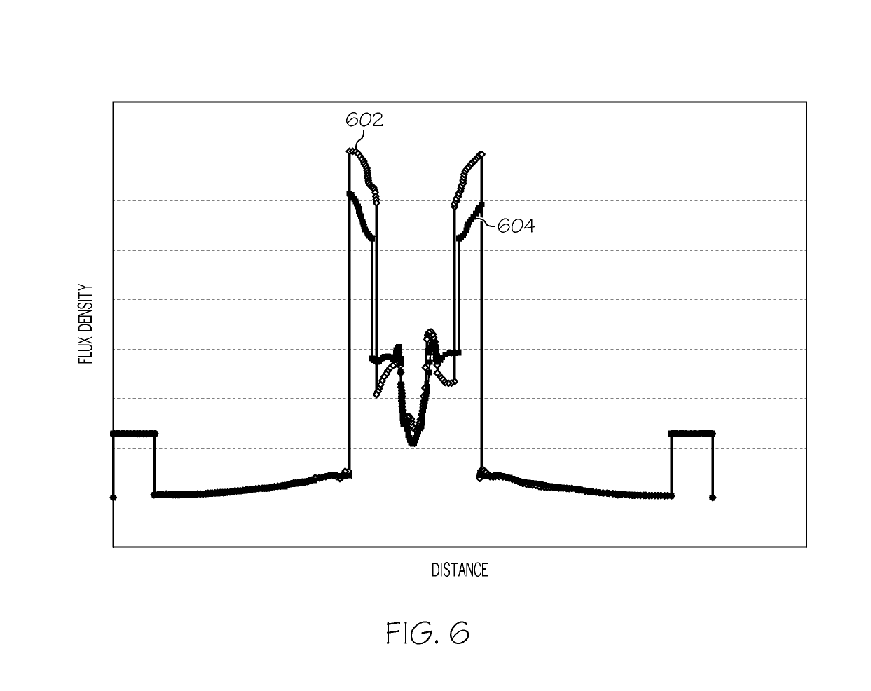

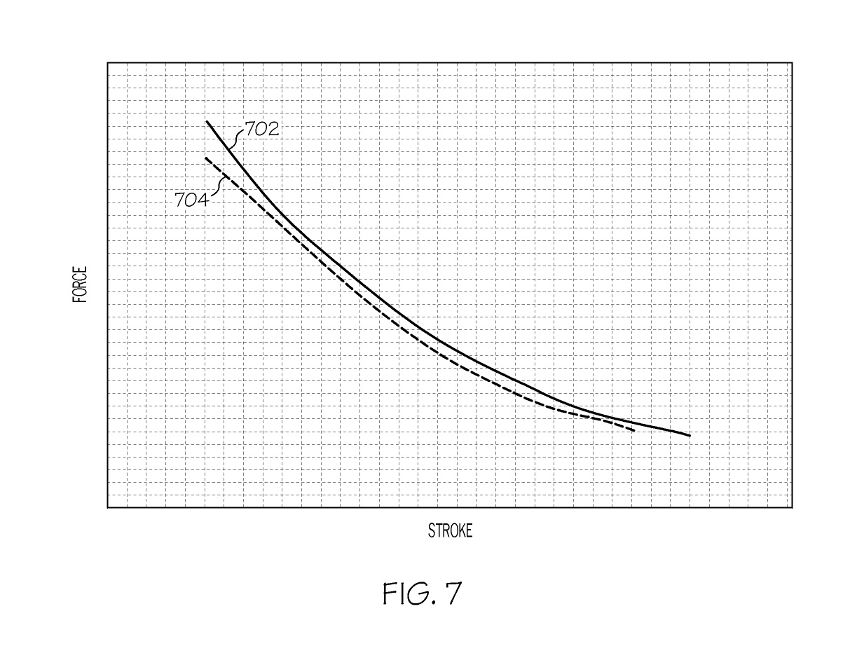

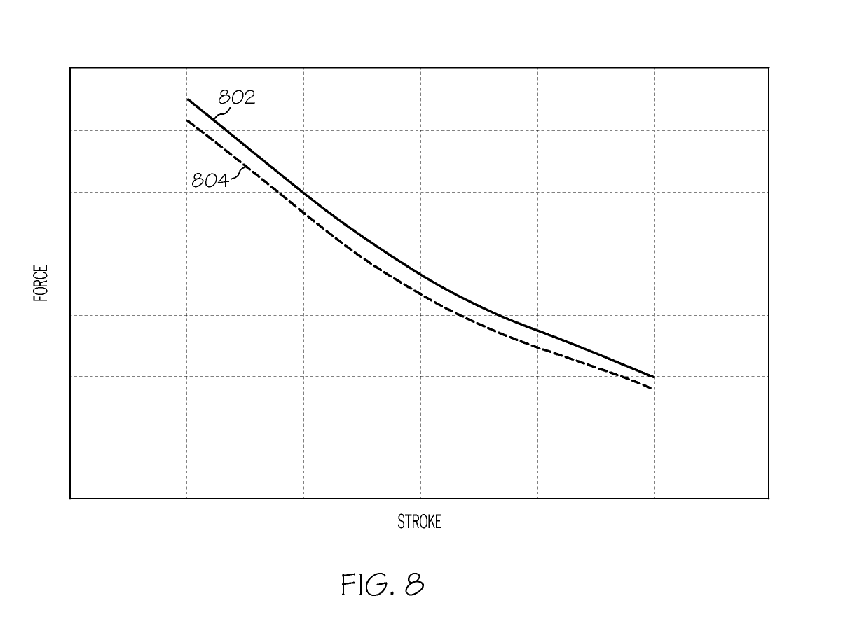

Because the armature seating surface 134 and the return pole engagement surface 144, due to the first and second surface features 136, 146, each have non-smooth topologies, the solenoid actuator 100 exhibits improved performance, as compared to similarly configured solenoid actuators with smooth topologies. For example, FIG. 6 depicts magnetic field density line plots for the solenoid actuator 100 depicted in FIGS. 1A AND 1B, and for a similarly configured, conventional solenoid actuator, in which the armature and the return pole engagement surfaces have smooth topologies. The magnetic field line plots taken along the section marked 6-6 in FIGS. 1A AND 1B. As these plots clearly show, the solenoid actuator with non-smooth topologies 602 (e.g., with grooves and protrusions) provides a higher magnetic field density in the working air gap, as compared to a solenoid actuator with conventional, smooth topologies 604. In addition, FIGS. 7 and 8 depict that the solenoid actuators 100, with non-smooth topologies 702, 802 (e.g., with grooves and protrusions) exhibits a higher force for a given stroke, as compared to solenoid actuators with conventional, smooth topologies 704, 804. It is noted that the exemplary graphs in FIGS. 7 and 8 are for conical cross sectional geometries with conical angles of 45-degrees and 53-degrees, respectively. However, as already noted various other cross sectional geometries and conical angles may be used.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A solenoid actuator, comprising:
a housing;
a coil disposed within the housing;
a return pole fixedly coupled to, and at least partially disposed within, the housing, the return pole including a return pole first end and a return pole second end, the return pole first end at least partially surrounded by the coil and defining an armature seating surface, the armature seating surface having a plurality of first surface features formed therein; and
an armature disposed at least partially within the housing and axially movable therein between a first position and a second position, the armature including an armature first end and an armature second end, the armature first end at least partially surrounded by the coil and defining a return pole engagement surface, the return pole engagement surface having a plurality of second surface features formed therein,
wherein:
when the armature is in the first position, the return pole engagement surface is spaced apart from the armature seating surface, and
when the armature is in the second position, the return pole engagement surface engages the armature seating surface and the first and second surface features interlock.

2. The solenoid actuator of claim 1, wherein:
each of the first surface features comprises a groove; and
each of the second surface features comprises a protrusion.

3. The solenoid actuator of claim 1, wherein each of the grooves and each of the protrusions have a saw tooth cross sectional shape.

4. The solenoid actuator of claim 1, wherein:
the armature seating surface and the return pole engagement surface each have a cross sectional shape; and
the cross sectional shape of the armature seating surface is complementary to the cross sectional shape of the return pole engagement surface.

5. The solenoid actuator of claim 4, wherein:
the armature seating surface has a concave, substantially conical cross sectional shape; and
the return pole engagement surface has a convex, substantially conical cross sectional shape.

6. The solenoid actuator of claim 4, wherein:
the armature seating surface has a convex, substantially conical cross sectional shape; and
the return pole engagement surface has a concave, substantially conical cross sectional shape.

7. The solenoid actuator of claim 1, wherein:
the coils is adapted to be selectively energized and is configured, upon being energized, to generate a magnetic field; and
the armature is configured to move to the first position when the coil is energized, and move to the second position when the coil is de-energized.

8. The solenoid actuator of claim 1, further comprising a spring disposed within the housing and supplying a bias force to the armature that urges the armature toward the first position.

9. The solenoid actuator of claim 1, further comprising an actuation rod coupled to, and movable with, the armature, the actuation rod extending from the housing and adapted to couple to a component.

10. The solenoid actuator of claim 9, wherein:
the return pole further includes a return pole bore that extends between the return pole first end and the return pole second; and
the actuation rod extends through the return pole bore.

11. The solenoid actuator of claim 10, further comprising a spring disposed within the return pole bore and engaging the return pole and the actuation rod, the spring supplying a bias force to the actuation rod, and thus the armature, that urges the armature toward the first position.

12. A solenoid actuator, comprising:
a housing;
a coil disposed within the housing;
a return pole fixedly coupled to, and at least partially disposed within, the housing, the return pole including a return pole first end and a return pole second end, the return pole first end at least partially surrounded by the coil and defining an armature seating surface, the armature seating surface having a plurality of protrusions formed thereon and extending therefrom; and
an armature disposed at least partially within the housing and axially movable therein between a first position and a second position, the armature including an armature first end and an armature second end, the armature first end at least partially surrounded by the coil and defining a return pole engagement surface, the return pole engagement surface having a plurality of grooves formed therein,
wherein:
when the armature is in the first position, the return pole engagement surface is spaced apart from the armature seating surface, and
when the armature is in the second position, the return pole engagement surface engages the armature seating surface and each protrusion is at least partially disposed within a different one of the grooves.

13. The solenoid actuator of claim 12, wherein each of the grooves and each of the protrusions have a saw tooth cross sectional shape.

14. The solenoid actuator of claim 12, wherein:
the armature seating surface and the return pole engagement surface each have a cross sectional shape; and
the cross sectional shape of the armature seating surface is complementary to the cross sectional shape of the return pole engagement surface.

15. The solenoid actuator of claim 14, wherein:
the armature seating surface has a concave, substantially conical cross sectional shape; and
the armature seating surface has a convex, substantially conical cross sectional shape.

16. A solenoid actuator, comprising:
a housing;
a coil disposed within the housing;
a return pole fixedly coupled to, and at least partially disposed within, the housing, the return pole including a return pole first end and a return pole second end, the return pole first end at least partially surrounded by the coil and defining an armature seating surface having a first cross sectional shape, the armature seating surface further having a plurality of grooves formed therein, each groove having a saw tooth cross sectional shape; and
an armature disposed at least partially within the housing and axially movable therein between a first position and a second position, the armature including an armature first end and an armature second end, the armature first end at least partially surrounded by the coil and defining a return pole engagement surface having a second cross sectional shape that is complementary to the first cross sectional shape, the return pole engagement surface further having a plurality of protrusions formed thereon and extending therefrom, each protrusion having a saw tooth cross sectional shape,
wherein:
when the armature is in the first position, the return pole engagement surface is spaced apart from the armature seating surface, and
when the armature is in the second position, the return pole engagement surface engages the armature seating surface and each protrusion is at least partially disposed within a different one of the grooves.

17. The solenoid actuator of claim 16, wherein:
the first cross sectional shape is a concave, substantially conical cross sectional shape; and
the second cross sectional shape is a convex, substantially conical cross sectional shape.

18. The solenoid actuator of claim 17, wherein:
the solenoid actuator has an index number;
the conical cross sections of the armature seating surface and the return pole engagement surface each have a conical angle; and
the index number (i) is defined as:
$$i = \frac{\sqrt{Force}}{Stroke} ,$$
where:
Force is mechanical load requirement, and
Stroke is stroke length or mechanical displacement of the armature.
